(19) United States
(12) Patent Application Publication
(10) Pub. No.: US 2022/0134607 A1
(43) Pub. Date: May 5, 2022

(54) PREFORM FIBER PLACEMENT ON A THREE-DIMENSIONAL SURFACE

(71) Applicant: GM GLOBAL TECHNOLOGY OPERATIONS LLC, Detroit, MI (US)

(72) Inventors: Venkateshwar R. AITHARAJU, Troy, MI (US); Princess Len M. CARLOS, Sterling Heights, MI (US); Donald E. MATTHEWS, Royal Oak, MI (US)

(73) Assignee: GM GLOBAL TECHNOLOGY OPERATIONS LLC, Detroit, MI (US)

(21) Appl. No.: 17/085,497

(22) Filed: Oct. 30, 2020

(51) Int. Cl. B29C 35/08; B29B 11/12; B29B 11/16

(52) U.S. Cl. CPC B29C 35/0805; B29B 11/12; B29K 2101/12; B29C 2035/0816; B29B 11/16

(57) ABSTRACT

A method of fabricating a preform is provided. The method includes disposing a veil over a first mold portion having a three-dimensional shape, the veil including a thermoplastic material and magnetic particles; disposing a fiber tow onto the veil; heating at least a portion of the veil by induction so that the fiber tow becomes coupled to the veil; compressing the fiber tow and the veil toward each other with a second mold portion that has a negative contour relative to the first mold portion; and removing the preform from the first and second mold portions. The preform has the three-dimensional shape and includes the fiber tow coupled to the veil. Preforms prepared by the method are also provided.

This section provides background information related to the present disclosure which is not necessarily prior art.

During the manufacture of some components of automotive vehicles, a flexible two-dimensional preform is pressed into a mold having a three-dimensional shape. When a portion of the preform does not tightly conform to a portion of the mold, slits are cut into the portion of the preform. When the preform suitably conforms to the mold, the mold is closed and a polymeric material is injected into the mold. The resulting component is a composite structure that includes the preform embedded within polymeric material.

### SUMMARY

This section provides a general summary of the disclosure, and is not a comprehensive disclosure of its full scope or all of its features.

The present disclosure relates to preform fiber placement on a three-dimensional surface.

In various aspects, the current technology provides a method of fabricating a preform, the method including disposing a veil over a first mold portion having a three-dimensional shape, the veil including a thermoplastic material and magnetic particles; disposing a fiber tow onto the veil; heating at least a portion of the veil by induction so that the fiber tow becomes coupled to the veil; compressing the fiber tow and the veil toward each other with a second mold portion that has a negative contour relative to the first mold portion; and removing the preform from the first and second mold portions, wherein the preform has the three-dimensional shape and includes the fiber tow coupled to the veil.

In one aspect, the thermoplastic material includes polypropylene, polystyrene, cellulose acetate, polytetrafluoroethylene (PTFE), nylon, a polyketone, polyvinyl chloride (PVC), polyvinylidene chloride (PVDC), polyvinyl acetate (PVA), polyvinyl alcohol (PVOH), polyacrylonitrile (PAN), poly(styrene-co-acrylonitrile), acrylonitrile butadiene styrene (ABS), polyacrylate, polymethacrylate, polyethylene, a polyamide, polyacetal (polyoxymethylene), polycarbonate, polyethylene terephthalate, polyethylene naphthalate, polybutylene terephthalate, polyacrylate, polyphenylene ether, polyphenylene sulfide, polysulfone, polyether sulfone, polyether ether ketone, polylactide, or combinations thereof.

In one aspect, the magnetic particles include iron (Fe), cobalt (Co), nickel (Ni), or combinations thereof.

In one aspect, the magnetic particles are at least one of embedded within the thermoplastic material or disposed on a surface of the thermoplastic material.

In one aspect, the method also includes, after the disposing the veil over the first mold portion, compressing the veil against the first mold portion with a roller.

In one aspect, the method also includes disposing a binder onto the veil and disposing the fiber tow onto the binder.

In one aspect, the heating the at least the portion of the veil by induction includes passing an alternating current through a coil to generate an alternating magnetic field and moving the coil relative to the at least a portion of the veil, wherein the alternating magnetic field contacts the magnetic particles and causes the magnetic particles to heat.

In one aspect, the heating the at least the portion of the veil by induction includes heating the veil to a temperature sufficient to cause the binder to at least partially melt, and optionally to cause the thermoplastic material to partially melt, so that the fiber tow becomes attached to the thermoplastic material.

In one aspect, the veil and the fiber tow are heated to a temperature greater than or equal to about 80° C. to less than or equal to about 120° C. during the compressing.

In one aspect, the method also includes disposing at least one additional fiber tow onto the fiber tow prior to the compressing.

In one aspect, the at least a portion of the veil heated by induction is at least a portion of the veil in which the fiber tow is not pulled into the veil by gravity.

In one aspect, the disposing the veil over the first mold portion is performed during a first step, the disposing the fiber tow onto the veil is performed during a second step, the compressing the fiber tow and the veil toward each other is performed during a third step, and the removing the preform from the mold is performed during a fourth step.

In one aspect, the disposing the veil over the first mold portion and the disposing the fiber tow onto the veil is performed during a first step, the compressing the fiber tow and the veil toward each other is performed during a second step, and the removing the preform from the mold is performed during a third step.

In various aspects, the current technology also provides a method of fabricating a preform, the method including disposing a veil over a first mold portion having a three-dimensional shape, the veil including a thermoplastic material and magnetic particles; compressing the veil onto the first mold portion with a roller; applying a binder layer to the veil; disposing a fiber tow onto the binder layer so that the binder layer is located between the veil and the fiber tow; moving an alternating magnetic field along at least a portion of the veil so that the alternating magnetic field contacts a portion of the magnetic particles at the at least a portion of the veil and causes the portion of the magnetic particles to heat by induction so that the fiber tow becomes coupled to the veil; while heating the veil, the binder layer, and the fiber tow, compressing the fiber tow and the veil toward each other with a second mold portion that has a negative contour relative to the first mold portion; and removing the preform from the first and second mold portions, wherein the preform has the three-dimensional shape and includes the fiber tow coupled to the veil.

In one aspect, the binder layer includes an epoxy powder.

In one aspect, the method also includes, prior to the moving the alternating magnetic field, applying a second binder layer on the fiber tow, disposing a second fiber tow onto the second binder layer, and optionally applying additional binder layers and disposing additional fiber tows onto the second fiber tow until a predetermined number of fiber tows are disposed on the veil.

In various aspect, the current technology further provides a preform having a matrix including a thermoplastic material and magnetic particles, the magnetic particles being at least one of embedded within the thermoplastic material or disposed on a surface of the thermoplastic material, and a fiber tow at least partially embedded within the matrix, wherein the preform has a substantially rigid three-dimensional shape.

In one aspect, the preform is not incorporated into a composite component.

In one aspect, the preform is at least partially embedded within a polymeric matrix.

In one aspect, the preform is in the shape of an automotive vehicle component.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1A is a first portion of a diagrammatic flow chart showing a method for fabricating a preform in accordance with various aspects of the current technology.

FIG. 1B is a continuation of the diagrammatic flow chart from FIG. 1A.

FIG. 1C is a continuation of the diagrammatic flow chart from FIG. 1B

FIG. 2A is an illustration of a first veil structure in accordance with various aspects of the current technology.

FIG. 2B is an illustration of a second veil structure in accordance with various aspects of the current technology.

FIG. 2C is an illustration of a third veil structure in accordance with various aspects of the current technology.

FIG. 3 is an illustration showing magnetic particles emitting heat within a veil as a result of contact from an alternating magnetic field in accordance with various aspects of the current technology.

FIG. 4 is a four-step process flow diagram for a preform fabrication method in accordance with various aspects of the current technology.

FIG. 5 is a three-step process flow diagram for a preform fabrication method in accordance with various aspects of the current technology.

FIG. 6A is an illustration of a first preform prepared in accordance with various aspects of the current technology.

FIG. 6B is an illustration of a second preform prepared in accordance with various aspects of the current technology.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology provides methods of fabricating a preform having a three-dimensional shape. For example, the preform can have the shape of an automobile component, such as an automobile floor, an automobile floor panel, a liftgate inner, a battery tub, a pillar, a suspension component, a crush can, a bumper beam, a structural front rail, a structural frame, a cross car beam, an undercarriage component, a truck bed panel, or a structural panel. Automobiles that can include the automobile component include cars, sedans, trucks, vans, motorcycles, recreational vehicles, and the like. In addition to automotive applications, the preform may also be used in other applications, such as aerospace applications (e.g., airplanes, helicopters, gliders, drones), nautical applications (e.g., ships, personal watercraft, docks), agricultural equipment, industrial equipment, military equipment, and the like, including non-vehicle applications. Because of the three-dimensional shape of the preform, it is receivable by a mold having a complementary shape and does not have to be adjusted or modified in order to retain the three-dimensional shape of the mold. For example, the three-dimensional preform prevents the need to cut slits into the preform at locations within the mold having complex three-dimensional shapes. The mold containing the preform can be used in, e.g., resin transfer molding, compression molding, sheet molding, thermoforming, injection molding, injection compression, and the like. A composite component including the preform results from the molding. Preforms fabricated from the methods are also provided.

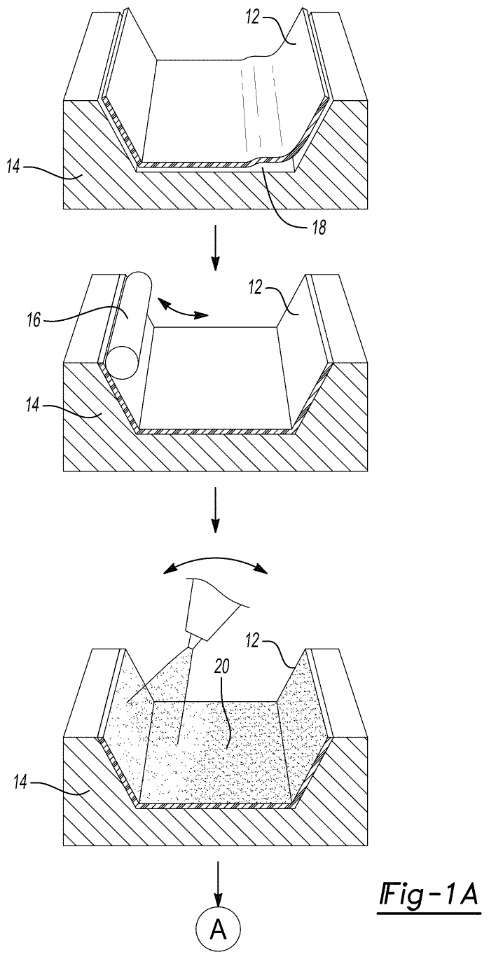

With reference to FIGS. 1A-1C, the current technology provides a method for fabricating a preform 10. The method comprises disposing a veil 12 over a first mold portion 14 having a three-dimensional shape. The veil 12 comprises a thermoplastic material and magnetic particles, which can be ferromagnetic particles. The thermoplastic material comprises polypropylene, polystyrene, cellulose acetate, polytetrafluoroethylene (PTFE), nylon, a polyketone, polyvinyl chloride (PVC), polyvinylidene chloride (PVDC), polyvinyl acetate (PVA), polyvinyl alcohol (PVOH), polyacrylonitrile (PAN), poly(styrene-co-acrylonitrile), acrylonitrile butadiene styrene (ABS), polyacrylate, polymethacrylate, polyethylene, a polyamide (e.g., PA6, PA11, PA12, PA46, PA66, PA610), polyacetal (polyoxymethylene), polycarbonate, polyethylene terephthalate, polyethylene naphthalate, polybutylene terephthalate, polyacrylate, polyphenylene ether, polyphenylene sulfide, polysulfone, polyether sulfone, polyether ether ketone, polylactide, or combinations thereof, as non-limiting examples. The magnetic particles comprise iron (Fe), cobalt (Co), nickel (Ni), oxides thereof, or combinations thereof, as non-limiting examples. The veil 12 is two-dimensional and flexible, such as a sheet, and can adopt the three-dimensional shape of the first mold portion 14.

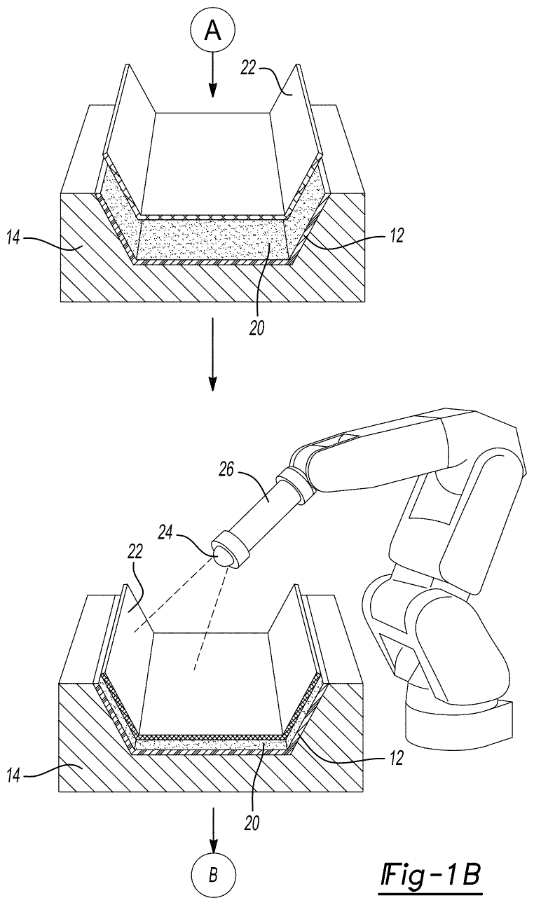

The magnetic particles are at least one of embedded within the thermoplastic material or disposed on a surface of the thermoplastic material. For example, FIG. 2A shows a portion of a veil 12a comprising a thermoplastic material 100 and magnetic particles 102. The magnetic particles 102 are embedded within the thermoplastic material 100. FIG. 2B shows a portion of a veil 12b comprising the thermoplastic material 100 and the magnetic particles 102. Here, the magnetic particles 102 are disposed on a surface 104 of the thermoplastic material 100. FIG. 2C shows a portion of a veil 12c comprising the thermoplastic material 100 and the magnetic particles 102. In the veil 12c, the magnetic particles 102 are disposed on a surface 104 of the thermoplastic material 100 and embedded within the thermoplastic material 100.

Referring back to FIGS. 1A-1C, the method also comprises compressing the veil 12 against the first mold portion 14 with a roller 16 or other tool, such as a flat blade. After compressing, the veil 12 and the first mold portion 14 are in close contact with each other and are substantially free of air pockets or wrinkles 18. By “substantially free of air pockets or wrinkles 18,” it is meant that there are no air pockets or wrinkles 18 that negatively affect the final three-dimensional structure of the preform 10.

Next, the method comprises applying a binder 20 to the veil 12. In some aspects, the binder 20 is a thermoplastic powder or an epoxy powder. An exemplary binder 20 is EPIKOTE™ TRAC 06720 epoxy binder (Hexion Inc.). The application of the binder 20 to the veil 12 is performed so that a layer comprising the binder 20 is disposed on the veil 12. The layer may be discontinuous so that the binder can be a powder comprising a plurality of binder particles, some of which are not in direct contact with each other. The binder 20 can be applied to the veil 12, for example, by spraying, dusting, brushing, pouring, or the like. The binder 20 is applied to a surface of the veil 12 to a concentration of greater than or equal to about 10 g/m² to less than or equal to about 25 g/m², including exemplary concentrations of about 10 g/mm², about 11 g/mm², about 12 g/mm², about 13 g/mm², about 14 g/mm², about 15 g/mm², about 16 g/mm², about 17 g/mm², about 18 g/mm², about 19 g/mm², about 20 g/mm², about 21 g/mm², about 22 g/mm², about 23 g/mm², about 24 g/mm², or about 25 g/mm².

After the binder 20 is applied to the veil 12, the method comprises disposing a fiber tow 22 onto the binder 20 so that the binder 20 is located between the veil 12 and the fiber tow 22. The fiber tow 22 is a reinforcing mat or fabric and comprises woven or nonwoven fibers. The fibers are carbon fibers, aramid fibers, glass fibers, inorganic polymer fibers, organic polymer fibers, or combinations thereof, as non-limiting examples. The disposing of the fiber tow 22 can be performed using a robot, such as a 6-axis or 8-axis robot.

In some aspects, the method also comprises applying a second layer comprising a binder, i.e., a second binder layer, on the fiber tow 22 and disposing a second fiber tow onto the second binder layer and optionally applying additional binder layers and disposing additional fiber tows onto the second fiber tow until a predetermined number of fiber tows are disposed on the veil. In other words, additional layers comprising a binder and fiber tows can be sequentially applied to the fiber tow 22 until a predetermined number of binder-fiber tow bilayers are disposed on the veil 12.

In yet other aspects, the fiber tow 22 or additional fiber tows are disposed over the veil 12 (with the binder 20 therebetween) at selected locations to provide additional reinforcement at areas of need. Therefore, in some aspects, the fiber tow 22 covers all or substantially all of the veil 12. Optionally, at least one additional fiber tow can be disposed over all, substantially all, or a portion of the fiber tow 22 with an additional binder layer disposed there between. As an example, the fiber tow 22 can cover all or substantially all of the veil 12 and a second fiber tow can be disposed over all or substantially of the first fiber tow 22. Additional fiber tows can be disposed completely or partially over the second fiber tow. As another example, the fiber tow 22 can cover all or substantially all of the veil 12 and one or a plurality of individual second fiber tows can be disposed over the fiber tow 22 at selected locations. Additional fiber tows can be disposed over at least one of the plurality of individual second fiber tows. In other aspects, the fiber tow 22 comprises one fiber tow disposed over a portion of the veil 12 or a plurality of individual fiber tows disposed over individual portions of the veil 12. Additional fiber tows can be disposed over the one fiber tow or over at least one of the plurality of individual fiber tows. It is understood that wherever a fiber tow is described herein as being disposed onto a veil or another fiber tow, a binder layer is applied first.

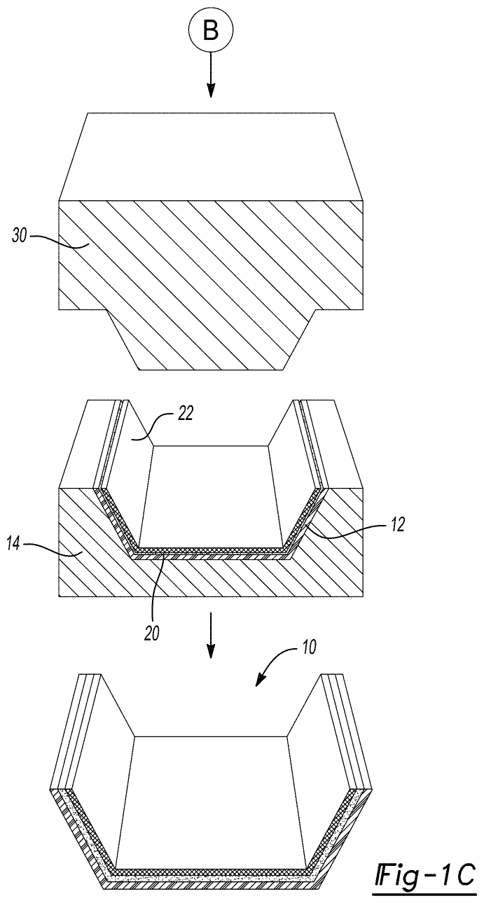

After the fiber tow 22 (or plurality of fiber tows) are disposed on the veil 12, with the binder 20 located between the veil 12 and the fiber tow 22 (or directly beneath each fiber tow of the plurality), the method comprises coupling the fiber tow 22 to the veil 12. Here, the veil 12 holds the fiber tow 22 so that the fiber tow 22 does not slip during subsequent processing. The coupling is performed by heating at least a portion of the veil 12 by induction so that the fiber tow 22 becomes coupled, or attached, to the veil 12 at the portion (or portions) being heated. Heating by induction is performed by passing an alternating current through a coil 24 to generate an alternating magnetic field and moving the coil 24 relative to the at least a portion of the veil 12, wherein the alternating magnetic field contacts the magnetic particles 102 and causes the magnetic particles 102 to heat. Moving the coil 24 can be performed by a robotic arm 26, to which the coil 24 is operably attached. Alternatively, the coil can be operated by an auxiliary unit of the robot that disposes the fiber tow 22. Heat radiating from the magnetic particles 102 at least partially melts the binder 20, localized at the heated area. As a result, the fiber tow 22 becomes attached to the veil 12 as the binder 20 cools. In some aspects, the heat radiating from the magnetic particles 102 also partially melts the thermoplastic material such that the fiber tow 22 becomes at least partially embedded within the thermoplastic material at the portion of the veil 12 being heated and becomes further attached to the veil 12 by way of the melted binder 20. As such, the heating is performed at a temperature sufficient to cause the thermoplastic material to partially melt at a desired location, such as at a temperature of greater than or equal to about 80° C. to less than or equal to about 160° C. As an example, FIG. 3 shows the coil 24 emitting an alternating magnetic field 28, wherein the alternating magnetic field 28 results from an alternating current traveling through the coil 24. The alternating magnetic field 28 contacts the magnetic particles 102 of the veil 12c (first depicted with reference to FIG. 2C). However, it is understood that any of the veils 12a, 12b, 12c from FIGS. 2A-2C can be positioned relative to the alternating magnetic field 28. The alternating magnetic field 28 results in the induction of eddy currents in the magnetic particles 102 causing the emission of heat, which at least partially melts the binder 20 and optionally partially melts the thermoplastic material 100. Heat can additionally be generated by hysteresis in ferromagnetic particles. It is noted that the binder 20 and the fiber tow 22 are not shown in the figure.

With renewed reference to FIGS. 1A-1C, the method next includes moving the coil 24 away from the portion of the veil 12 being heated so that the portion cools. As the portion of the veil 12 cools, the fiber tow 22 becomes coupled, or attached, to the veil 12 by way of the binder 20 and optionally by way of the veil 12 when it becomes partially melted. In various aspects, the at least a portion of the veil 12 that is heated by induction is at least a portion of the veil 12 in which the fiber tow 22 is not pulled into the veil 12 by gravity (i.e., the Earth's downward gravitation pull). In other words, it may be beneficial to heat portions of the veil 12 that are not horizontal, i.e., that are not substantially parallel to the Earth, such as vertical or angled portions of the veil 12. Notwithstanding, it is understood that any portion of the veil 12, including horizontal, angled, and vertical portions, can be heated in order to have the fiber tow 22 coupled to that portion of the veil 12.

Next, the method comprises compressing the fiber tow 22 and the veil 12 toward each other with a second mold portion 30 that has a negative contour relative to the first mold portion 14. The compressing may include applying a downward force from the second mold portion 30 toward the first portion 14 with the veil 12 and fiber tow 22 therebetween, wherein the downward force is applied at a pressure of greater than or equal to about 0.1 MPa to less than or equal to about 1 MPa or greater than or equal to about 0.1 MPa to less than or equal to about 0.7 MPa. During the compressing, the veil 12, the binder 20, and the fiber tow 22 are heated to a temperature greater than or equal to about 80° C. to less than or equal to about 120° C., which activates the binder 20. The method then includes cooling the veil 12, the binder 20, and the fiber tow 22, during which the fiber tow 22 becomes consolidated into, i.e., coupled to, the veil 12 and forms the preform 10, wherein the preform has the three-dimensional shape derived from the first and second mold portions 14, 30 and comprises the fiber tow 22 coupled to the veil 12. The method further includes removing the preform 10 from the first and second mold portions 14, 30, such as by a robot or robotic arm.

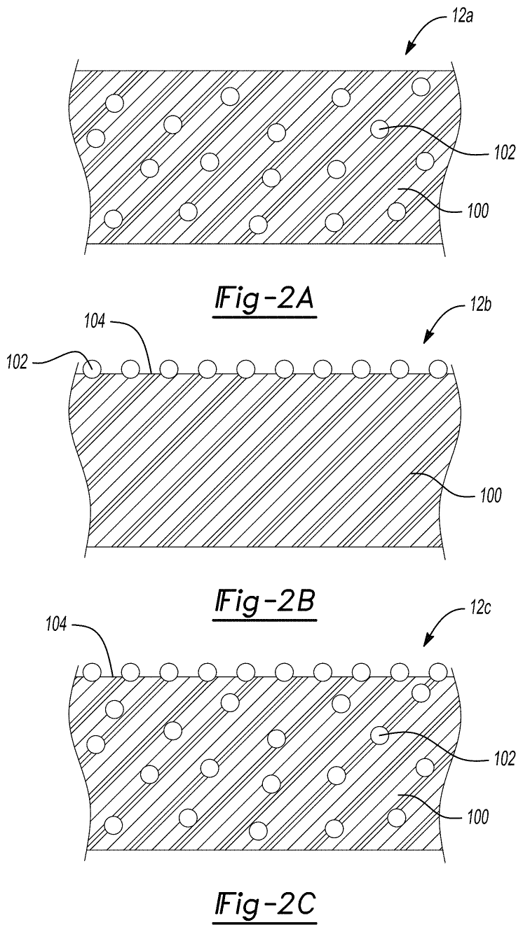

FIG. 4 shows a four-step process flow diagram 40 for the method described with reference to FIGS. 1A-1C. Here, the disposing the veil 12 over the first mold portion 14 and the compressing the veil 12 against the first mold portion 14 is performed during a first step 42. The applying the binder 20, the disposing the fiber tow 22 onto the binder 20, and the heating the veil 12 by induction is performed during a second step 44. Then, the compressing the fiber tow 22 and the veil 12 toward each other using the first and second mold portions 14, 30 while heating is performed during a third step 46. In a fourth step 48, the preform 10 is removed from the first and second mold portions 14, 30.

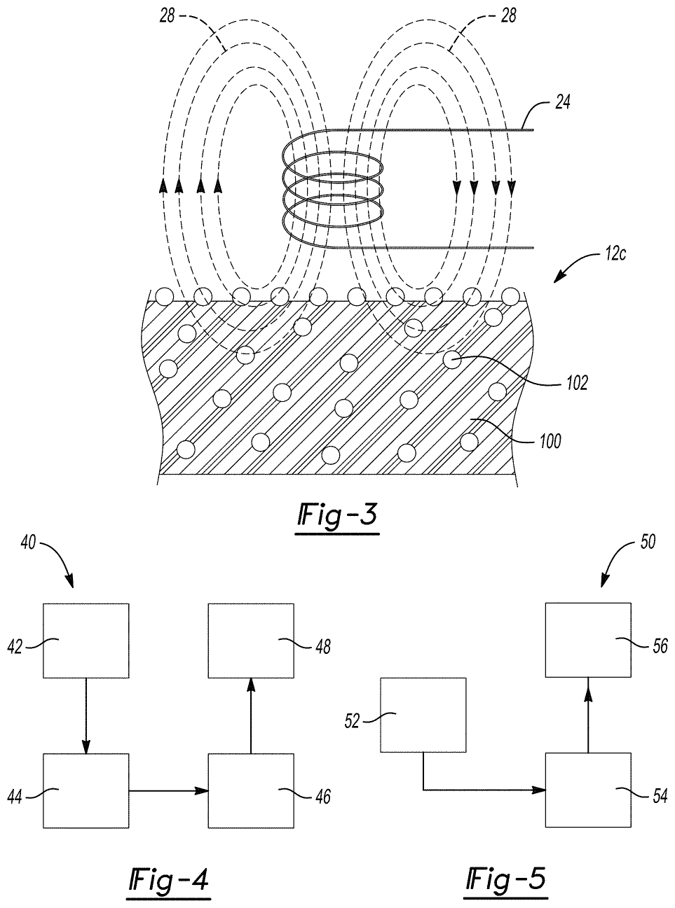

A three-step process flow diagram 50 is shown in FIG. 5. Here, the first and second steps 52, 54 of the four-step process flow diagram 40 of FIG. 4 are combined into a single first step 52. As such, the first step 52 includes the disposing the veil 12 over the first mold portion 14, the compressing the veil 12 against the first mold portion 14, the applying the binder 20 to the veil 12, the disposing the fiber tow 22 onto the binder 20, and the heating the veil 12 by induction. Then, the compressing the fiber tow 22 and the veil 12 toward each other using the first and second mold portions 14, 30 while heating is performed during a second step 54. In a third step 56, the preform 10 is removed from the first and second mold portions 14, 30.

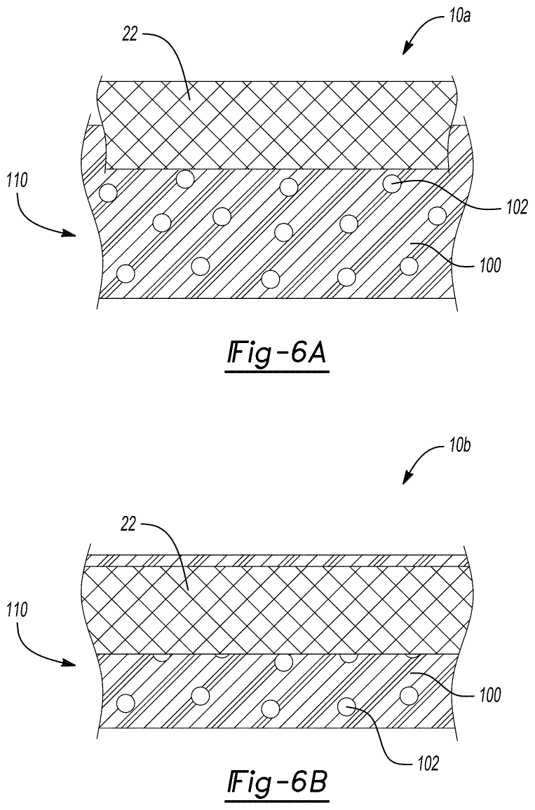

With reference to FIG. 6A, the method generates a preform 10a comprising a matrix 110 that includes the thermoplastic material 100 and the magnetic particles 102, as described with reference to FIGS. 2A-2C. More particularly, the matrix 110 is a bulk material defined by the thermoplastic material 100. The preform 10a also includes the fiber tow 22 (described with reference to FIGS. 1A-1C) partially embedded within the matrix 110. With reference to FIG. 6B, the method also generates a preform 10b, which is the same as the preform 10a of FIG. 6A, except that the fiber tow 22 is completely embedded within the matrix 110. The preforms 10a, 10b of FIGS. 6A and 6B are substantially rigid. By “substantially rigid,” it is meant that the preforms 10a, 10b retain a three-dimensional shape as discussed above, but may have some flexibility.

The preform 10 can be provided as a stand-alone article, i.e., not incorporated into a composite component. However, the preform 10 has the three-dimensional shape, as discussed above. In some aspects, the preform 10 is at least partially embedded within a polymeric matrix as a result of a molding process. Put another way, a composite component prepared by a molding process using the preform includes the preform at least partially embedded within a polymeric matrix. Any suitable molding process may be employed for forming the composite component, including resin transfer molding, liquid compression molding, sheet molding, thermoforming, injection compression, and the like. Generally, the molding process includes placing the preform 10 into a mold. A polymer or polymer precursor can then be introduced (e.g., injected) under pressure to fill in voids and pores within the preform 10. Then, elevated temperatures, elevated pressures, or both may be applied within the mold so that the polymer, or a polymer derived from the polymer precursor, is retained in and about the preform.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of fabricating a preform, the method comprising:
disposing a veil over a first mold portion having a three-dimensional shape, the veil comprising a thermoplastic material and magnetic particles;
disposing a fiber tow onto the veil;
heating at least a portion of the veil by induction so that the fiber tow becomes coupled to the veil;
compressing the fiber tow and the veil toward each other with a second mold portion that has a negative contour relative to the first mold portion; and
removing the preform from the first and second mold portions,
wherein the preform has the three-dimensional shape and comprises the fiber tow coupled to the veil.

2. The method according to claim 1, wherein the thermoplastic material comprises polypropylene, polystyrene, cellulose acetate, polytetrafluoroethylene (PTFE), nylon, a polyketone, polyvinyl chloride (PVC), polyvinylidene chloride (PVDC), polyvinyl acetate (PVA), polyvinyl alcohol (PVOH), polyacrylonitrile (PAN), poly(styrene-co-acrylonitrile), acrylonitrile butadiene styrene (ABS), polyacrylate, polymethacrylate, polyethylene, a polyamide, polyacetal (polyoxymethylene), polycarbonate, polyethylene terephthalate, polyethylene naphthalate, polybutylene terephthalate, polyacrylate, polyphenylene ether, polyphenylene sulfide, polysulfone, polyether sulfone, polyether ether ketone, polylactide, or combinations thereof.

3. The method according to claim 1, wherein the magnetic particles comprise iron (Fe), cobalt (Co), nickel (Ni), or combinations thereof.

4. The method according to claim 1, wherein the magnetic particles are at least one of embedded within the thermoplastic material or disposed on a surface of the thermoplastic material.

5. The method according to claim 1, further comprising, after the disposing the veil over the first mold portion:
compressing the veil against the first mold portion with a roller.

6. The method according to claim 1, further comprising:
disposing a binder onto the veil; and
disposing the fiber tow onto the binder.

7. The method according to claim 1, wherein the heating at least a portion of the veil by induction comprises:
passing an alternating current through a coil to generate an alternating magnetic field; and
moving the coil relative to the at least a portion of the veil, wherein the alternating magnetic field contacts the magnetic particles and causes the magnetic particles to heat.

8. The method according to claim 7, wherein the heating the at least the portion of the veil by induction comprises heating the veil to a temperature sufficient to cause the binder to at least partially melt, and optionally to cause the thermoplastic material to partially melt, so that the fiber tow becomes attached to the thermoplastic material.

9. The method according to claim 1, wherein the veil and the fiber tow are heated to a temperature greater than or equal to about 80° C. to less than or equal to about 120° C. during the compressing.

10. The method according to claim 1, further comprising disposing at least one additional fiber tow onto the fiber tow prior to the compressing.

11. The method according to claim 1, wherein the at least a portion of the veil heated by induction is at least a portion of the veil in which the fiber tow is not pulled into the veil by gravity.

12. The method according to claim 1, wherein the disposing the veil over the first mold portion is performed during a first step, the disposing the fiber tow onto the veil is performed during a second step, the compressing the fiber tow and the veil toward each other is performed during a third step, and the removing the preform from the mold is performed during a fourth step.

13. The method according to claim 1, wherein the disposing the veil over the first mold portion and the disposing the fiber tow onto the veil is performed during a first step, the compressing the fiber tow and the veil toward each other is performed during a second step, and the removing the preform from the mold is performed during a third step.

14. A method of fabricating a preform, the method comprising:
disposing a veil over a first mold portion having a three-dimensional shape, the veil comprising a thermoplastic material and magnetic particles;
compressing the veil onto the first mold portion with a roller;
applying a binder layer to the veil;
disposing a fiber tow onto the binder layer so that the binder layer is located between the veil and the fiber tow;
moving an alternating magnetic field along at least a portion of the veil so that the alternating magnetic field contacts a portion of the magnetic particles at the at least a portion of the veil and causes the portion of the magnetic particles to heat by induction so that the fiber tow becomes coupled to the veil;
while heating the veil, the binder layer, and the fiber tow, compressing the fiber tow and the veil toward each other with a second mold portion that has a negative contour relative to the first mold portion; and
removing the preform from the first and second mold portions,
wherein the preform has the three-dimensional shape and comprises the fiber tow coupled to the veil.

15. The method according to claim 14, wherein the binder layer comprises an epoxy powder.

16. The method according to claim 14, further comprising, prior to the moving the alternating magnetic field:
applying a second binder layer on the fiber tow;
disposing a second fiber tow onto the second binder layer; and
optionally applying additional binder layers and disposing additional fiber tows onto the second fiber tow until a predetermined number of fiber tows are disposed on the veil.

17. A preform comprising:
a matrix comprising a thermoplastic material and magnetic particles, the magnetic particles being at least one of embedded within the thermoplastic material or disposed on a surface of the thermoplastic material; and
a fiber tow at least partially embedded within the matrix,
wherein the preform has a substantially rigid three-dimensional shape.

18. The preform according to claim 17, wherein the preform is not incorporated into a composite component.

19. The preform according to claim 17, where the preform is at least partially embedded within a polymeric matrix.

20. The preform according to claim 17, wherein the preform is in the shape of an automotive vehicle component.
